(19) United States
(12) Patent Application Publication
(10) Pub. No.: US 2006/0276135 A1
(43) Pub. Date: Dec. 7, 2006

(54) Antenna control method and system

(75) Inventors: Ting-Yi Tsai, Taipei City (TW); Gwo-Yun Lee, Fongshan City (TW); Jia-Haur Liang, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Accton Technology Corporation

(21) Appl. No.: 11/363,611

(22) Filed: Feb. 28, 2006

(30) Foreign Application Priority Data
Jun. 3, 2005 (TW) 94118465
Jun. 13, 2005 (TW) 94119541

(51) Int. Cl. H04B 1/00; H04M 1/00; H04B 15/00

(52) U.S. Cl. 455/63.4; 455/562.1

(57) ABSTRACT

An antenna control method and system is disclosed. First, output a transmission signal to an antenna apparatus to generate a main beam. The antenna apparatus has a number of antenna units arranged in a line. Next, adjust the direction of the main beam by changing phase of the transmission signal. Afterward, determine whether there is a wireless signal in the direction of the main beam. If yes, acquire direction or location of a client generating the wireless signal according to the wireless signal. Finally, control the maximum energy point of the main beam to be located at the client according to the direction or location of the client. The antenna apparatus is for receiving the transmission signal outputted by a phase shifter to generate the main beam, and the transmission signal comprises a number of sub-transmission signals of different phases.

This application claims the benefit of Taiwan applications Serial No. 94118465, filed Jun. 3, 2005 and Taiwan application Serial No. 94119541, filed Jun. 13, 2005, the subject matter of which are incorporated herein by reference.

### BACKGROUND OF THE INVENTION

1. Field of the Invention

The invention relates in general to an antenna control method and system, and more particularly to an antenna control method and system applied in an access point.

2. Description of the Related Art

Acquiring information via internet has become a current trend. Conventional internet transmits data through a specific transmission line and the user has to access internet at a specific location in a building through the transmission line. The usage of wireless local area network solves the inconvenience that the user has to access internet through a transmission line. However, how to ensure correct data transmission without using transmission lines is becoming a focus in development of the wireless network technology.

FIG. 1A is a schematic diagram showing the radiation field of an omni-directional antenna apparatus in an access point (AP). In wireless local area network, when signals are transmitted by omni-directional antenna technology, it can be seen from FIG. 1A that the electromagnetic energy is radiated and spread out uniformly from the omni-directional antenna apparatus. However, most of the electromagnetic energy decays as reflected by obstacles, and thus the client cannot receive the transmitted data. Furthermore, the omni-directional antenna apparatus receiving signals in a large range easily generates noise interference.

FIG. 1B is a simulation diagram showing the radiation field of a directional antenna apparatus in an access point. The radiation filed of FIG. 1B has a main beam 110. In order to solve the above-mentioned issue of the omni-directional antenna apparatus, the directional antenna focuses electromagnetic energy in the main beam 110 and emits the main beam 110 in a specific direction. The main beam 110 covers the wireless signals outputted by clients in that specific direction. Compared to the omni-directional antenna apparatus having the same electromagnetic energy in every direction, the directional antenna apparatus focuses electromagnetic energy in the main beam 110 to transmit signals to a longer distance. However, if the client is not located in the range of the main beam 110, it cannot receive the signals send by the electromagnetic energy.

Therefore, how to transmit signals to a longer distance and solve the issue that the client cannot receive signals as it is not located in the range of the main beam is an essential subject of developing an access point. Besides, when the client moves, the quality of signal reception is also influenced.

### SUMMARY OF THE INVENTION

It is therefore an object of the invention to provide an antenna control method and system. The purpose of improving the directional antenna can be achieved by controlling phases of the transmission signals to change the direction of the main beam.

The invention achieves the above-identified object by providing an antenna control method applied in an access point. The antenna control method includes outputting a transmission signal to at least an antenna apparatus to generate a main beam, wherein the antenna apparatus has a plurality of antenna units and arranged in a line; changing phase of the transmission signal to adjust the direction of the main beam; determining whether there is a wireless signal in the direction of the main beam, if not, continue to adjust the direction of the main beam to search for a wireless signal; acquiring direction or location of a client generating the wireless signal according to the wireless signal; and controlling the maximum energy point of the main beam to be located at the client according to the direction or location of the client. The antenna apparatus is for receiving the transmission signal outputted by a phase shifter to generate the main beam, and the transmission signal comprises a plurality of sub-transmission signals of different phases.

The invention achieves the above-identified object by providing an antenna control system applied in an access point. The antenna control system includes at least an antenna apparatus, a phase shifter, wireless signal detector, and a control circuit. The antenna apparatus is for receiving a transmission signal to generate a main beam. The transmission signal includes a number of sub-transmission signals of different phases, and the antenna apparatus includes a number of antenna units arranged in a line. The phase shifter is for adjusting a phase of the transmission signal to change direction of the main beam. The wireless signal detector is for determining whether the main beam covers a wireless signal, and outputting a determination signal. The control circuit is for outputting a control signal to control the phase shifter to output the transmission signal to the antenna apparatus and determining whether the main beam covers the wireless signal. If the main beam covers the wireless signal, the control circuit acquires the direction or location of a client generating the wireless signal according to the determination signal, and positions the maximum energy point of the main beam at the client.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a schematic diagram showing the radiation field of an omni-directional antenna apparatus in an access point (AP).

FIG. 1B (Prior Art) is a simulation diagram showing the radiation field of a directional antenna apparatus in an access point.

FIG. 2 is a block diagram of the antenna control system of an access point according to a preferred embodiment of the invention.

FIG. 3 is a flow chart of an antenna control method applied in an access point according to the preferred embodiment of the invention.

FIG. 4 is a flow chart of acquiring the location or direction of the client according to the wireless signal.

FIG. 5A and FIG. 5B are diagrams of the first structure of the antenna apparatus.

FIGS. 6A, 6B, 6C, and 6D are simulation diagrams of a radiation field of the antenna apparatus illustrated in FIG. 5A and FIG. 5B.

FIG. 7 is a diagram of the second structure of the antenna apparatus.

FIGS. 8A, 8B, 8C, and 8D are simulation diagrams of a radiation filed of the antenna apparatus of FIG. 7.

FIG. 9A is a flow chart of a positioning method in a 2-D plane.

FIG. 9B is a schematic diagram of antenna apparatus arrangement according to a positioning method in a 2-D plane.

FIG. 10A is a flow chart of a positioning method in a 3-D space.

FIG. 10B is a schematic diagram of the antenna apparatus arrangement according to the poisoning method in a 3-D space.

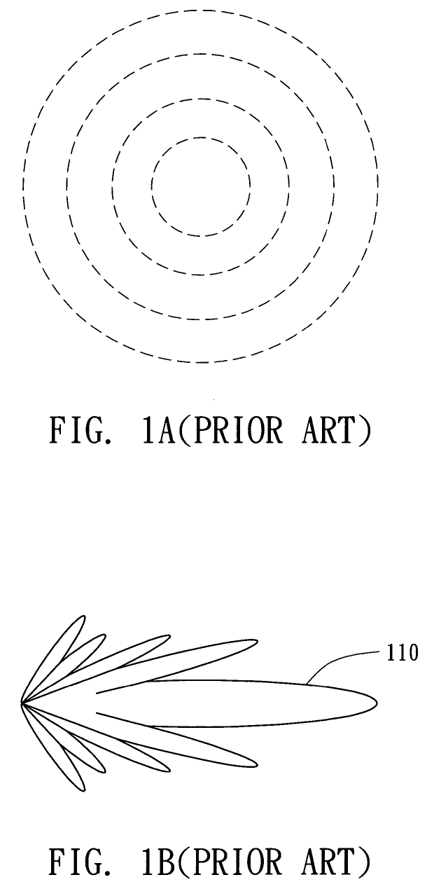

### DETAILED DESCRIPTION OF THE INVENTION

The main ideas of the invention lies on the direction and wave-peak location of the main beam is adjusted by changing the phase of the inputted transmission signal so that the main beam is not limited to a fixed range and direction. In addition, the wave-peaks of the main beam are controlled to be located at the client generating a wireless signal and noise signal interference is removed so as to have a better signal receiving quality.

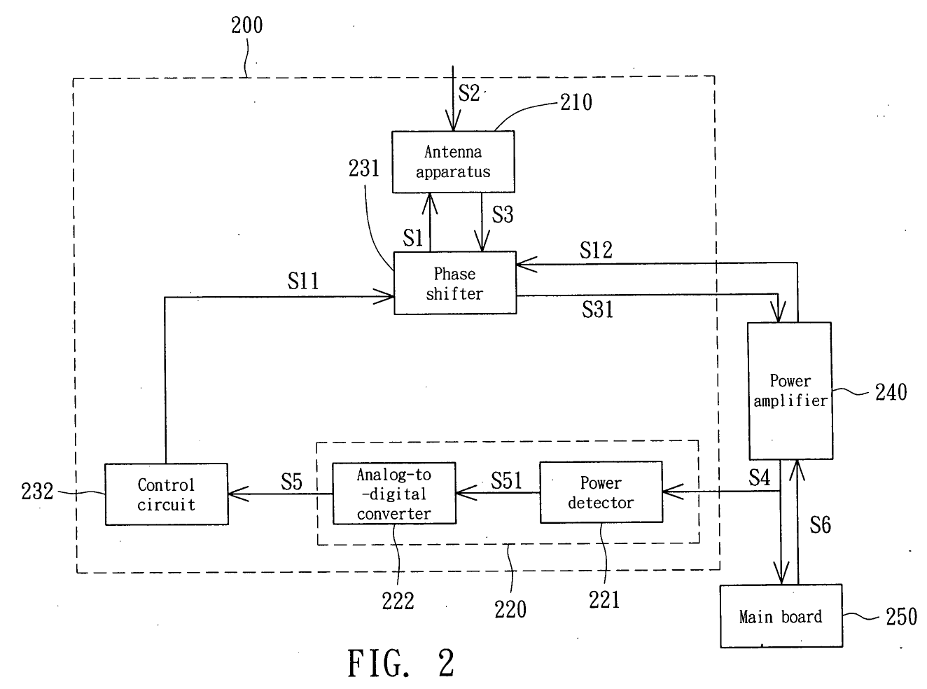

Referring to FIG. 2, a block diagram of the antenna control system of an access point according to a preferred embodiment of the invention is shown. The antenna control system 200 includes an antenna apparatus 210, a phase shifter 231, a wireless signal detector 220 and a control circuit 232. The antenna apparatus 210 generates a main beam according to the transmission signal S1 outputted by the phase shifter 231, and the number of the antenna apparatuses 210 can be changed according to a practical requirement. If there is a wireless signal, such as the signal S2, in the main beam range, a reception signal S3 is generated according to the wireless signal S2. If there is no wireless signal in the main beam range, the phase shifter 231 changes the phase of the transmission signal S1. The phase shifter 231 shifts a phase angle α of the main beam to search for the wireless signal, and generates a feedback signal S31 according to the reception signal S3. The antenna control system 200 is electrically coupled to a power amplifier 240. The power amplifier 240 receives the feedback signal S31 and then adjusts power of the feedback signal S31 to output a power signal S4. The wireless signal detector 220 determines if the main beam generated by the antenna apparatus 210 covers any wireless signal and outputs a determination signal S5 accordingly. The control circuit 232 controls the phase shifter 231 to output the transmission signal S1 to the antenna apparatus 210 by outputting a control signal S11 and determines whether the main beam covers the wireless signal S2 according to the determination signal S5. If the main beam covers the wireless signal S2, the control circuit 232 acquires a direction or location of the client according to the determination signal S5. The wireless signal S2 is generated by the client and the control circuit 232 controls the maximum energy point of the main beam to be located at the direction or location of the client. The number of the antenna apparatus 210 is determined according to the direction or location of the client. For example, a single antenna apparatus 210 can be used to acquire the direction of a client while a number of antenna apparatuses 210 can be used to acquire the location of a client.

The power amplifier 240 is electrically coupled to a main board 250. The main board 250 performs signal processing on the power signal S4. When the antenna system 200 is to transmit data, the main board 250 performs the signal processing to generate an output signal S6 while the output signal S6 is adjusted via the power amplifier 240 to output a radiation signal S12 to the phase shifter 231.

Furthermore, the antenna control system 200 is electrically coupled to the power amplifier 240 so as to prevent that the wireless signal detector 220 cannot effectively detect the wireless signal S2 due to power insufficiency of the feedback signal S31. The power amplifier 240 outputs the power signal S4 to the wireless signal detector 220 after adjusting the power of the feedback signal S31.

The wireless signal detector 220 further includes a power detector 221 and an analog-to-digital converter 222. The power detector 221 detects the power of the power signal S4 and then outputs a detect signal S51. The analog-to-digital converter 222 performs analog-to-digital conversion on the detect signal S51 and then outputs a determination signal S5 to the control circuit 232. The control circuit 232 determines whether there is any wireless signal S2 in the main beam range and the power of the wireless signal S2 detected within the main beam range according to the determination signal S5, and then outputs a control signal S11 to control the phase shifter 231 to output the transmission signal S1 to the antenna apparatus 210, thereby shifting the main beam of the antenna apparatus 210 or positioning the maximum energy point of the main beam at the client generating the wireless signal S2. Moreover, if the power signal S4 outputted by the power amplifier 240 has still insufficient power, an extra power amplifier (not shown in the figure) can be disposed in the wireless signal detector 220 to receive and amplify the power signal S4 and then output the amplified signal to the power detector 221.

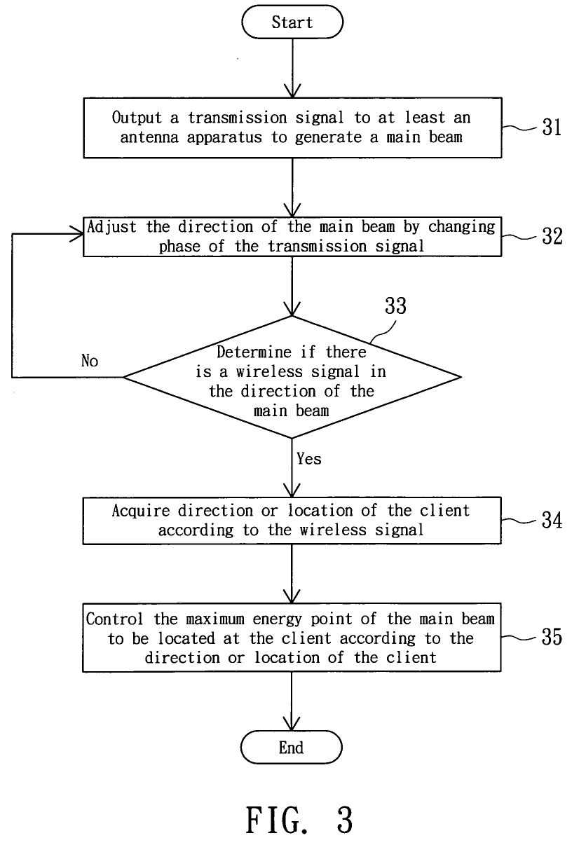

Referring to FIG. 3, a flow chart of an antenna control method applied in an access point according to the preferred embodiment of the invention is shown. The antenna control method includes five steps. First, in step 31, output the transmission signal S1 to at least an antenna apparatus 210 to generate a main beam. Next, in step 32, adjust the phase of the transmission signal S1 to change the direction of the main beam. Afterward, in step 33, determine whether there is a wireless signal in the direction of the main beam. If there is no wireless signal, return to the step 32. Following that, in step 34, if there is a wireless signal, such as the signal S2, in the main beam range, acquire the location or direction of the wireless signal S2. Finally, in step 35, control the maximum energy point of the main beam to be located at the client according to the location or direction of the client.

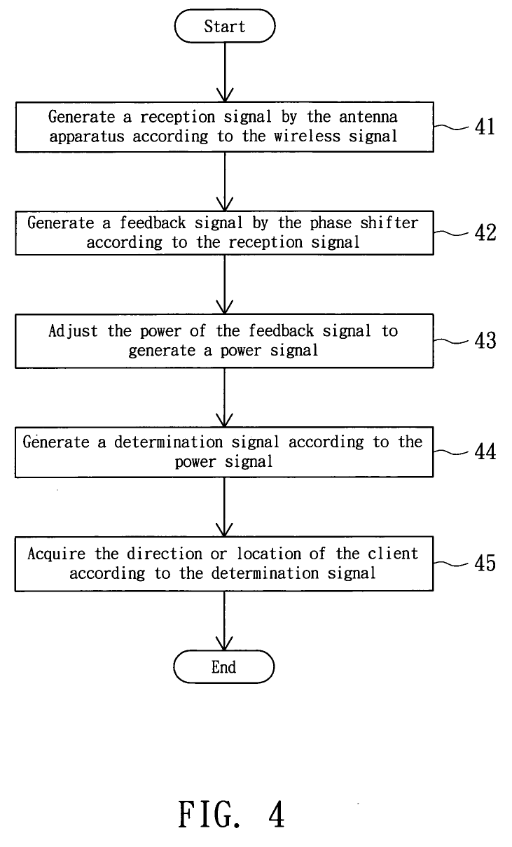

Referring to FIG. 4, a flow chart of acquiring the location or direction of the client according to the wireless signal is shown. The above-mentioned step 34 further includes the following steps. First, in step 41, the antenna apparatus 210 generates the reception signal S3 according to the wireless signal S2. Next, in step 42, the phase shifter 231 generates the feedback signal S31 according to the reception signal S3. Afterward, in step 43, adjust the power of the feedback signal S31 to generate the power signal S4. In step 44, generate the determination signal S5 according to the power signal S4. Finally, in step 45, acquire the location or direction of the client according to the determination signal S5.

The antenna apparatus 210 used in the antenna control method and antenna control system 200 has two design structures as follows.

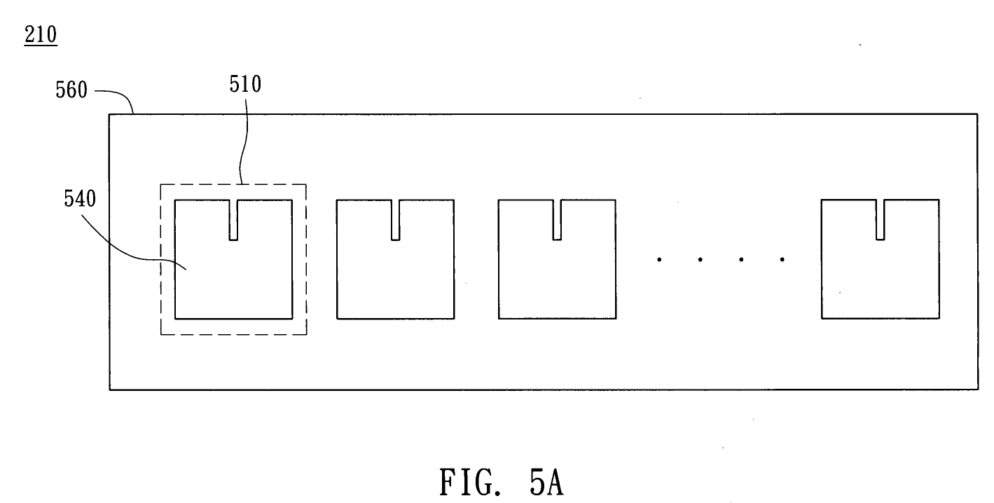

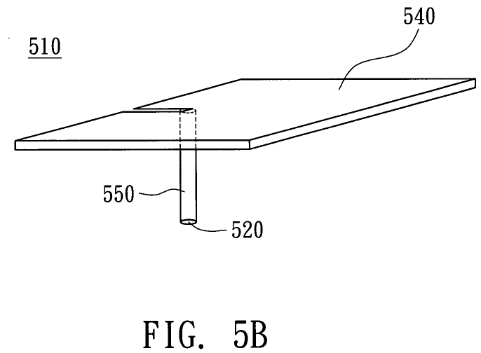

Referring to FIG. 5A and FIG. 5B at the same time, diagrams of the first structure of the antenna apparatus are shown. The antenna apparatus 210 is for receiving the transmission signal S1 outputted by the phase shifter 231 to generate a main beam. The transmission signal S1 includes a number of sub-transmission signals of different phases. The antenna apparatus 210 includes a number of antenna units 510 arranged in a line and a metal reflected plate 560. The metal reflected plate 560 has an area larger than an area sum of all antenna units 510. The antenna unit 510 includes a feed-in point 520, a radiation body 540 and a holder 550. The radiation body 540 is a metal sheet. The feed-in point 520 is for receiving one of the sub-transmission signals. The holder 550 is made of metal for supporting the radiation body 540. The holder 550 has one end electrically coupled to the radiation body 540 and the other end electrically coupled to the feed-in point 520. The antenna apparatus 210 generates the main beam for performing the above-mentioned control method and control system operation according to the transmission signal S1.

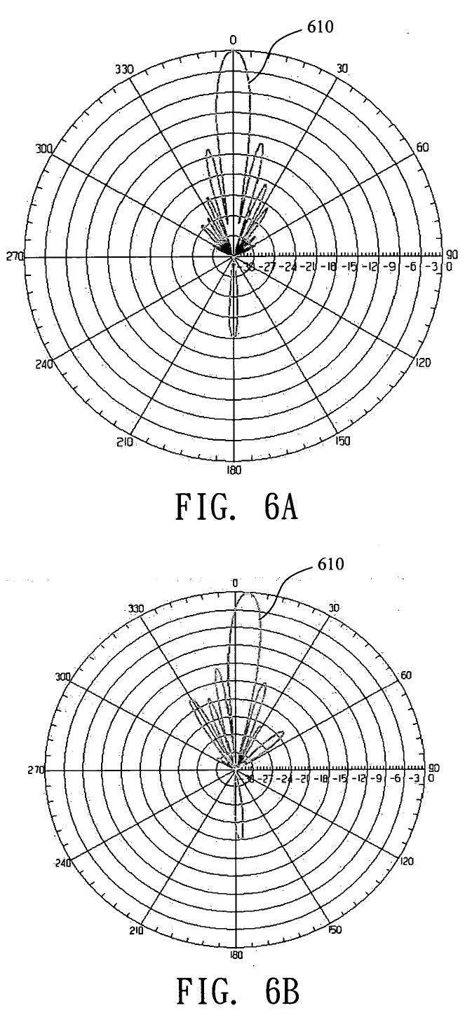

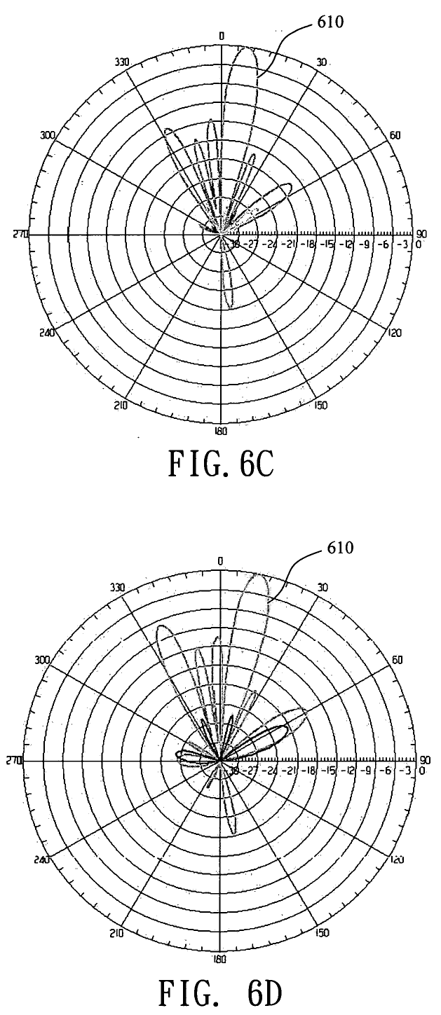

Referring to FIGS. 6A, 6B, 6C, and 6D, simulation diagrams of a radiation field of the antenna apparatus illustrated in FIG. 5A and FIG. 5B are shown. In FIG. 6A, the transmission signal S1 has a phase angle α equal to 0 degree, and the main beam 610 is supposed to have an inclined angle θ equal to 0 degree relative to a plane. In FIG. 6B, the transmission signal S1 has a phase angle α equal to 40 degrees, and it can be seen that the angle θ of the main beam 610 relative to the plane is clockwise rotated to 4 degrees. In FIG. 6C, the transmission signal S1 has a phase angle α equal to 80 degrees, and it can be seen that the angle θ of the main beam 610 relative to the plane is clockwise rotated to 8 degrees. In FIG. 6D, the transmission signal S1 has a phase angle α equal to 120 degrees, and it can be seen that the angle θ of the main beam 610 relative to the plane is clockwise rotated to 12 degrees. As mentioned above, the direction of the main beam can be obviously adjusted by just changing the phase angle α of the transmission signal S1 via the phase shifter 231. By adjusting the phase angle α of the transmission signal S1 generated by the phase shifter 231, the relative angle θ of the main beam can be changed from 0 to 90 degrees, thereby achieving the purpose of orientating the main beam to detect the wireless signal.

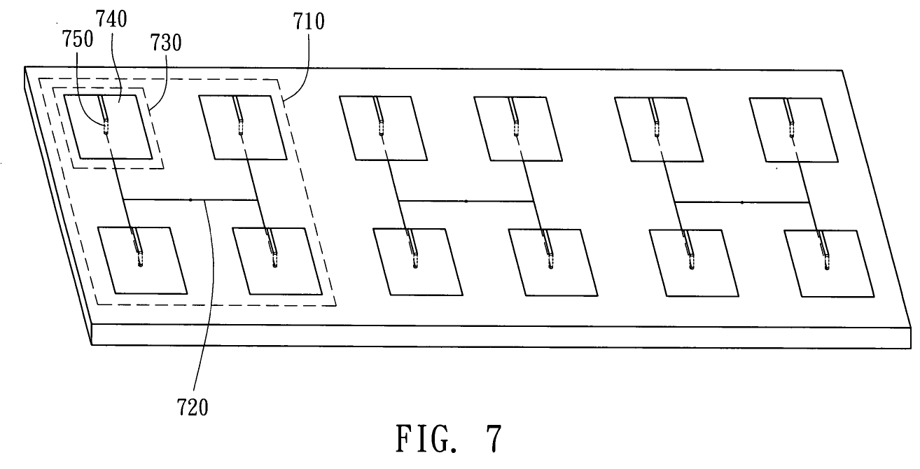

Referring to FIG. 7, a diagram of the second structure of the antenna apparatus is shown. The antenna apparatus 210 can be designed as that in FIG. 7 except for that in FIG. 5A and FIG. 5B. The antenna apparatus includes a number of antenna units 710, and the antenna units 710 can be antenna arrays. In FIG. 7, the antenna apparatus 210 is implemented by three antenna units 710 arranged in a line. The antenna 710 is electrically coupled to the phase shifter 231 for receiving the transmission signal S1 and generating the main beam. The transmission signal S1 includes a number of sub-transmission signals of different phases, which are outputted to the antenna units 710.

The antenna unit 710 includes a feed-in line 720 and a number of antenna elements 730. The feed-in line 720 is for receiving the transmission signal S1 outputted by the phase shifter 231. The antenna elements 730 receive the transmission signals S1 outputted by the phase shifter 231 via the feed-in line 720. The antenna elements 730 are arranged in a form of an N×M matrix, wherein N and M are positive integers. A 2×2 matrix is taken for an example for the antenna element 730 in FIG. 7. The antenna element 730 includes a radiation body 740, such as a metal sheet, and a holder 750. The holder is made of metal for supporting the radiation body 740, and is electrically coupled to the radiation body 740 and the feed-in line 720.

The above-mentioned antenna apparatus 210 generates a main beam according to the transmission signal S1 outputted by the phase shifter 231. The direction of the main beam can be changed according to the phases of the sub-transmission signals. When the wireless signal S2 is located in the direction of the main beam, the control circuit 232 acquires the direction or location of the client according to the wireless signal S2. Finally, the control circuit 232 controls the antenna apparatus 210 to position the maximum energy point of the main beam at the client according to the direction or location of the client.

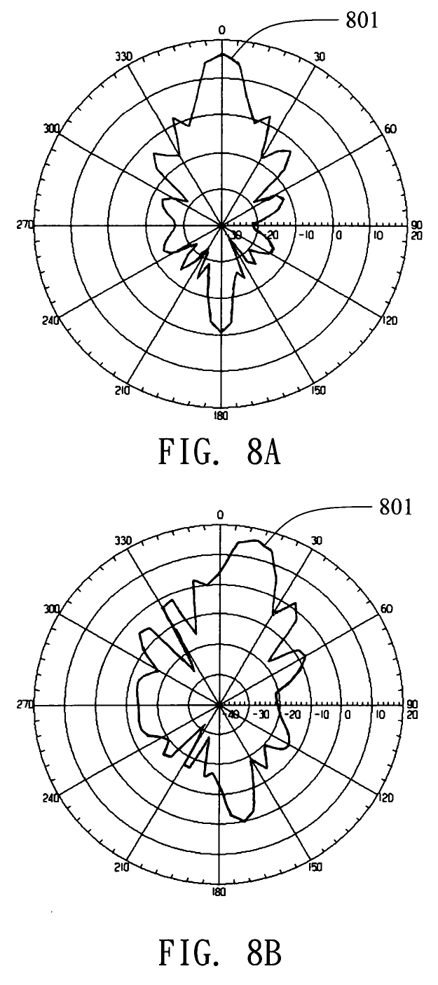

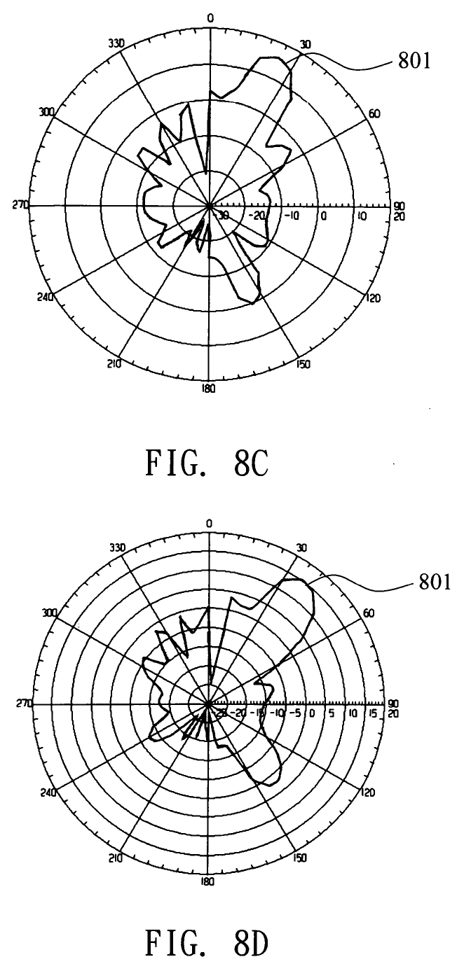

Referring to FIGS. 8A, 8B, 8C, and 8D at the same time, simulation diagrams of a radiation filed of the antenna apparatus of FIG. 7 are shown. In FIG. 8A, the transmission signal S1 has a phase angle α (not shown in the figure) equal to 0 degree, and the main beam 801 is supposed to have an inclined angle θ equal to 0 degree relative to a plane. In FIG. 8B, the transmission signal S1 has a phase angle α equal to 40 degrees, and it can be seen that the angle θ of the main beam 801 relative to the plane is clockwise rotated to 13 degrees. In FIG. 8C, the transmission signal S1 has a phase angle α equal to 80 degrees, and it can be seen that the angle θ of the main beam 801 relative to the plane is clockwise rotated to 24 degrees. In FIG. 8D, the transmission signal S1 has a phase angle α equal to 120 degrees, and it can be seen that the angle θ of the main beam 801 relative to the plane is clockwise rotated to 36 degrees.

As mentioned above, the direction of the main beam can be obviously adjusted by just changing the phase angle α of the transmission signal S1 via the phase shifter 231. By adjusting the phase angle α of the transmission signal S1 generated by the phase shifter 231, the relative angle θ of the main beam can be changed from 0 to 90 degrees, thereby achieving the purpose of orientating the main beam to detect the wireless signal.

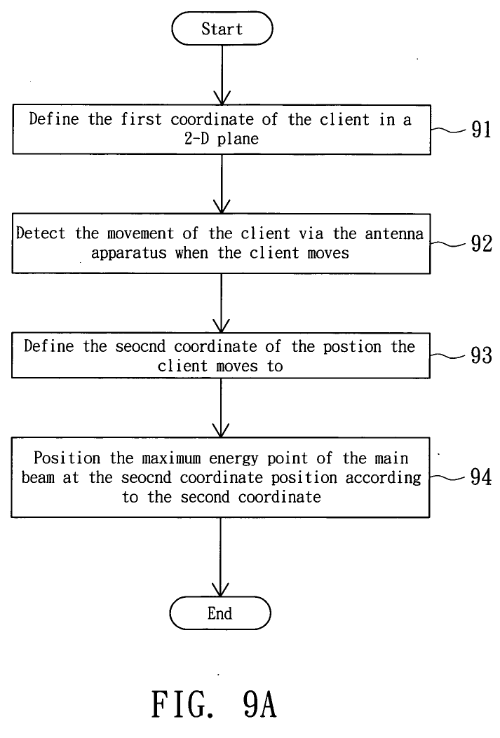

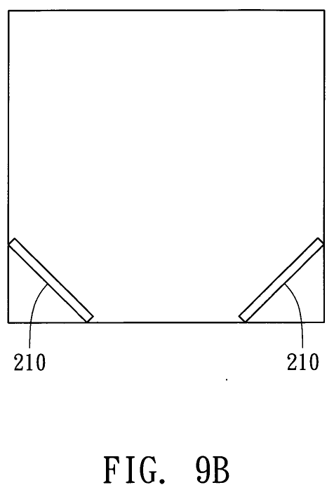

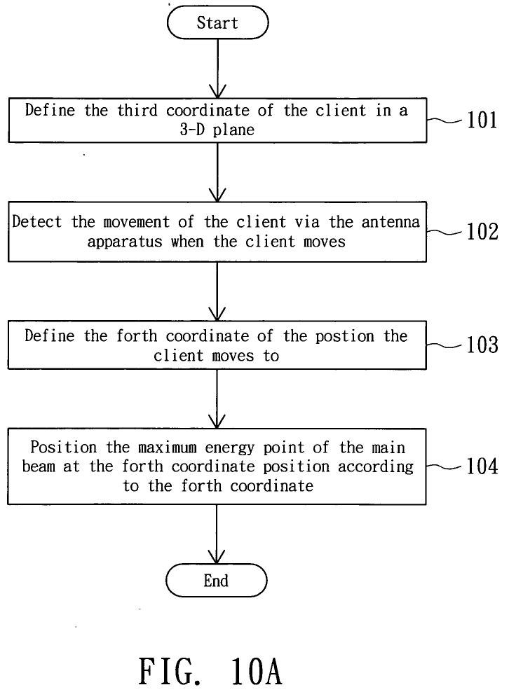

Therefore, by way of the above-mentioned two antenna apparatus design, when the client generating the wireless signal S2 moves, by using a number of antenna apparatuses 210, the location of the clients can be defined via coordinate frames to achieve a positioning effect. Referring to FIG. 9A, a flow chart of a positioning method in a 2-D plane is shown. First, in step 91, define the first coordinate of the client in a 2-D plane. Next, in step 92, when the client moves, detect the movement of the client via the antenna apparatus 210. Afterward, in step 93, define a second coordinate of the position the client moves to. Finally, in step 94, position the maximum energy point of the main beam at the second coordinate position according to the second coordinate.

Referring to FIG. 9B, a schematic diagram of antenna apparatus arrangement according to a positioning method in a 2-D plane is shown. If the client moves continuously, the main beam adjusts its direction continuously also so that its wave-peak can keep on to be positioned at the client. At least two antenna apparatuses 210 are required to achieve the above-mentioned positioning method in a 2-D plane. In the embodiment, two antenna apparatuses 210 are respectively configured at symmetrical corners of the 2-D plane as shown in FIG. 9B. In positioning process, the main beams generated from the two antenna apparatuses 210 adjust their directions and ranges continuously so that the client is located at the intersection of the two main beams. Therefore, the first coordinate of the client before moving and the second coordinate of the client after moving can be defined in the 2-D plane. The maximum energy point of the main beam can thus be positioned at the second coordinate position according to the second coordinate and the client can receive signals of good quality. The invention is not limited to using two antenna apparatuses 210 to achieve 2-D positioning effect. The number of the antenna apparatuses can be adjusted according to the practical environment. However, at least two antenna apparatuses are required to define coordinates of a 2-D plane.

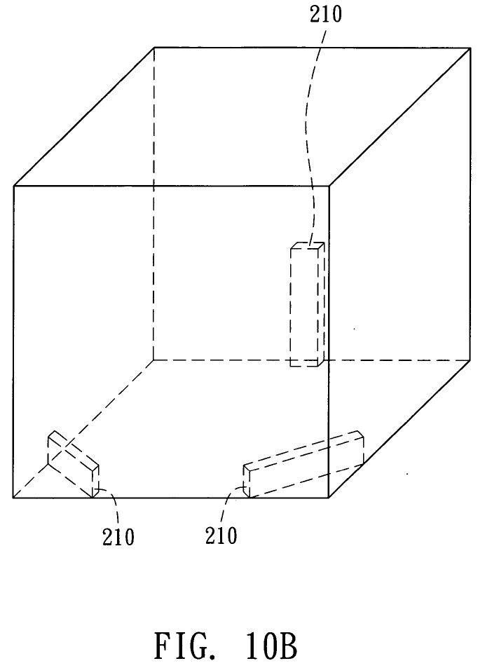

Referring to FIG. 10A, a flow chart of a positioning method in a 3-D space is shown. First, in step 101, define a third coordinate of the client in a 3-D plane. Next, in step 102, when the client moves, detect the movement of the client via the antenna apparatus 210. Afterward, in step 103, define the forth coordinate of the position the client moves to. Finally, in step 104, position the maximum energy point of the main beam at the forth coordinate position according to the forth coordinate.

In order to define a 3-D space, the third antenna apparatus 210 should not be located at the same plane with the other two antenna apparatuses 210. Referring to FIG. 10B, a schematic diagram of the antenna apparatus arrangement according to the poisoning method in a 3-D space is shown. When the client moving in a room is to be positioned in a 3-D space, in order to position the wave-peak of the main beam at the client, at least three antenna apparatuses 210 are required to complete the above-mentioned 3-D positioning method. Except that two of the antenna apparatuses 210 are respectively configured on a 2-D plane and located at two symmetric corners, in order to define the height of a 3-D space, the third antenna apparatus 210 has to stand upright on the 2-D plane, and the third antenna apparatus 210 can be moved up and down in a direction vertical to the 2-D plane as required. As a result, the third coordinate of the client before moving and the forth coordinate of the client after moving can be defined in a 3-D space. The maximum energy point of the main beam can be positioned at the forth coordinate position according to the forth coordinate, and thus the client can receive signals of good quality. However, the invention is not limited to using only three antenna apparatuses 210 to achieve a 3-D positioning effect. The number of the antenna apparatuses can be adjusted according to the environment, but at least three antenna apparatuses 210 are required to define the coordinates of a 3-D space.

According to the antenna control method and system disclosed by the above-mentioned embodiment of the invention, the main beam can be adjusted to position the wave-peak of the main beam, which has the best signal transmission effect, at the client and move the noise signals out of the main beam range to achieve the best signal transmission quality. Moreover, the invention can even position the moving client to maintain signal transmission quality. The antenna control method and system in the invention can be applied to an indoor environment as well as an outdoor environment.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An antenna control method, applied in an access point, comprising:
outputting a transmission signal to at least an antenna apparatus to generate a main beam, wherein the antenna apparatus has a plurality of antenna units and arranged in a line;
changing phase of the transmission signal to adjust the direction of the main beam;
determining whether there is a wireless signal in the direction of the main beam, if not, continue to adjust the direction of the main beam to search for a wireless signal;
acquiring direction or location of a client generating the wireless signal according to the wireless signal; and
controlling the maximum energy point of the main beam to be located at the client according to the direction or location of the client;
wherein the antenna apparatus is for receiving the transmission signal outputted by a phase shifter to generate the main beam, and the transmission signal comprises a plurality of sub-transmission signals of different phases.

2. The antenna control method according to claim 1, wherein the maximum energy point of the main beam is located at a wave-peak of the main beam.

3. The antenna control method according to claim 1, wherein the step of acquiring the direction or location of a client comprises:
generating a reception signal by the antenna apparatus according to the wireless signal;
generating a feedback signal by the phase shifter according to the reception signal;
adjusting power of the feedback signal to generate a power signal;
detecting and performing analog-to-digital conversion on the power of the power signal to generate a determination signal; and
acquiring the direction or location of the client according to the determination signal.

4. The antenna control method according to claim 1, further comprising a positioning step, wherein the positioning step comprises:
defining a first coordinate of the client in a 2-D plane;
detecting the movement of the client via the antenna apparatus as the client moves;
defining a second coordinate of the position the client moves to; and
positioning the maximum energy point of the main beam at the second coordinate position according to the second coordinate.

5. The antenna control method according to claim 4, wherein in the step of defining the first coordinate of the client in the 2-D plane, at least two antenna apparatuses are used to define the 2-D plane.

6. The antenna control method according to claim 1, further comprising a positioning step, wherein the positioning step comprises:
defining a first coordinate of the client in a 3-D space;
detecting the movement of the client via the antenna apparatus when the client moves;
defining a second coordinate of the position the client moves to; and
positioning the maximum energy point of the main beam at the second coordinate position according to the second coordinate.

7. The antenna control method according to claim 6, wherein in the step of defining the first coordinate of the client in the 3-D space, at least three antenna apparatuses are used to define the 3-D space.

8. An antenna control system, applied in an access point, comprising:
at least an antenna apparatus, for receiving a transmission signal to generate a main beam, the transmission signal comprising a plurality of sub-transmission signals of different phases, the antenna apparatus comprising a plurality of antenna units arranged in a line;
a phase shifter, for adjusting a phase of the transmission signal to change direction of the main beam;
a wireless signal detector, for determining whether the main beam covers a wireless signal, and outputting a determination signal; and
a control circuit, for outputting a control signal to control the phase shifter to output the transmission signal to the antenna apparatus, and determining whether the main beam covers the wireless signal, wherein if the main beam covers the wireless signal, the control circuit acquires the direction or location of a client generating the wireless signal according to the determination signal, and positions the maximum energy point of the main beam at the client.

9. The antenna control system according to claim 8, wherein each of the antenna units comprises:
a feed-in point, for receiving one of the sub-transmission signals;
a radiation body, made of a metal sheet; and
a holder, made of metal, for supporting the radiation body, the holder having one end electrically coupled to the radiation body and the other end electrically coupled the feed-in point.

10. The antenna control system according to claim 8, wherein each of the antenna unit comprises:
a feed-in line, for receiving one of the sub-transmission signals; and
a plurality of antenna elements, arranged in a N×M matrix, for receiving the sub-transmission signal via the feed-in line, wherein N and M are positive integers, and each of the antenna element comprises:
a radiation body, made of a metal sheet; and
a holder, made of metal, for supporting the radiation body, wherein the holder is electrically coupled to the radiation body and the feed-in line.

11. The antenna control system according to claim 8, wherein the maximum energy point of the main beam is located at a wave-peak of the main beam.

12. The antenna control system according to claim 8, wherein the antenna control system is electrically coupled to a power amplifier, the antenna apparatus outputs a reception signal according to the wireless signal, the phase shifter outputs a feedback according to the reception signal, the power amplifier adjusts the power of the feedback signal to output a power signal to the wireless signal detector, and the wireless signal detector detects and performs analog-to-digital conversion on the power signal to output the determination signal.

13. The antenna control system according to claim 12, wherein the power amplifier is electrically coupled to a main board and performs signal processing on the power signal.

14. The antenna control system according to claim 13, wherein the main board generates an output signal, the power amplifier adjusts the power of the output signal to output a radiation signal to the phase shifter.

15. The antenna control system according to claim 12, wherein the wireless signal detector further comprises:
a power detector, for detecting the power of the power signal and outputting a detection signal; and
an analog-to-digital converter, for performing analog-to-digital conversion on the detection signal and outputting the determination signal to the control circuit.

16. The antenna control system according to claim 8, wherein the control circuit defines a first coordinate of the client in a 2-D plane, detects the movement of the client via the antenna apparatus to define a second coordinate of the position the client moves to when the client moves, and positions the maximum energy point of the main beam at the second coordinate position according to the second coordinate.

17. The antenna control system according to claim 16, wherein the control circuit defines the 2-D plane by at least two antenna apparatuses.

18. The antenna control system according to claim 8, wherein the control circuit defines a first coordinate of the client in a 3-D space, detects the movement of the client to define a second coordinate of the position the client moves to when the client moves, and positions the maximum energy point of the main beam at the second coordinate position according to the second coordinate.

19. The antenna control system according to claim 18, wherein the control circuit uses at least three antenna apparatuses to define the 3-D space.
